(19) United States
(12) Patent Application Publication
(10) Pub. No.: US 2006/0164417 A1
(43) Pub. Date: Jul. 27, 2006

(54) Imagery-based synthetic environment for computer generated forces

(75) Inventors: Kenneth Burton Donovan, Apalachin, NY (US); Michael J. Longtin, Orlando, FL (US)

Correspondence Address: WELSH & KATZ, LTD, 120 S RIVERSIDE PLAZA, 22ND FLOOR, CHICAGO, IL, 60606, US

(73) Assignee: Lockheed Martin Corporation

(21) Appl. No.: 11/300,672

(22) Filed: Dec. 14, 2005

Related U.S. Application Data
(63) Continuation-in-part of application No. 10/900,646, filed on Jul. 28, 2004.
(60) Provisional application No. 60/637,544, filed on Dec. 20, 2004.

(51) Int. Cl. G06T 17/00

(52) U.S. Cl. 345/428

(57) ABSTRACT

Systems and methods usable to provide synthetic environments for computer generated forces include supplemental identifying information applicable to the respective surface. Polygons used to represent the surface can be overlayed with supplemental information to provide a higher fidelity environment in which to mobilize the computer generated forces.

### CROSS-REFERENCE TO RELATED APPLICATION

This is a continuation-in-part of U.S. patent application Ser. No. 10/900,646 filed Jul. 28, 2004 for “Material Coded Imagery For Computer Generated Forces” and claims the benefit of a Dec. 20, 2004 filing date for Provisional Application No. 60/637,544 entitled “Imagery-based Synthetic Environment For Computer Generated Forces”.

### FIELD OF THE INVENTION

The invention pertains to systems and methods for the generation of synthetic environments for training or mission rehearsal. More particularly, the invention pertains to systems and methods to increase speed of creation and accuracy of landscapes for virtual battlefields which might be traversed by computer generated forces.

### BACKGROUND OF THE INVENTION

There is a continuing and ongoing need to be able to generate authentic synthetic environments in connection with training or exercise rehearsal. For example, aircraft or vehicular simulators provide more realistic simulations and enhance the training and/or rehearsal experiences of the participants by using dynamically changing, real time, out the window displays or scenes. Particularly in connection with aircraft, these displays can represent large areas of terrain which can be viewed, preferably in real time, by the participant. Such displays require large databases derived from, for example, satellite images, high altitude photography or the like.

The databases and display equipment must be able to take into account widely changing scenes relative to a common area which could include take offs or landings, as well as high or low altitude engagements with simulated adversaries. One such approach has been disclosed and claimed in published U.S. patent application 2004/0075667 A1, assigned to the Assignee hereof and entitled System and Related Methods for Synthesizing Color Imagery, incorporated by reference herein.

Realistic simulation experiences will likely include computer generated forces (CGF) or semi-automated forces (SAF) which move across the displayed terrain, a synthetic environment, and exhibit behavior consistent with terrain features such as water, trees, buildings and the like. Typical forces could include tanks, self-propelled artillery, boats, as well as mechanized or dismounted infantry.

Terrain databases for modeling and simulation are known and commercially available. Commercially available software can be used to process such databases and, for example, extract features or the like. In addition commercially available software can be used to create and automate both friendly and enemy forces.

Many known CGF databases require vector-based feature representations. The process of extracting features can, as a result be time consuming and expensive. Such databases can include both physical features and abstract features.

Physical features are those that have a physical significance such as buildings, trees, tree canopies, roads and the terrain surface. Physical features affect the outcome of “physical calculations”, such as elevation queries, intervisibility queries, and soil attribution queries for mobility. Traditional physical features are of two general types, the terrain polygons and the lineal/point feature overlay, as shown in FIG. 2A, left side.

The terrain polygons provide the foundational representation for the Compact Terrain Database (CTDB) for both the surface elevation and attributes. The surface elevation is defined by the 3D terrain polygons (triangulated irregular network or “TIN”.) The surface material is defined by a set of attributes associated with each 3D terrain polygon. A soil type query requires searching for the polygon that spatially contains the query point location and then accessing the soil attribute of that polygon. Encoding surface attributions in this manner requires subdividing the elevation TIN or “ITIN”,) regardless of whether the features have differing elevations. This increases the complexity and number of terrain polygons in the ITIN.

Relatively small features, such as roads or buildings would generate a very large number of ITIN polygons. CTDB provides an optional efficiency to represent these smaller features as an overlay that sits on top of the base terrain polygons. An overlay feature is one that is defined to exist on the terrain surface, conforms to the underlying elevation of the terrain, and overrides the surface attributes of the underlying terrain polygon. Roads and rivers can be represented this way in CTDB.

The CTDB overlay representation of roads and rivers has the advantage of compact storage space, but this efficiency comes at a price. Overlay features are limited in deriving their elevations from the underlying terrain polygons. Overlay features cannot directly represent fine elevation changes around the feature, such as cut-and-fill roads or riverbanks. This type of micro terrain detail requires integrating the features into the terrain skin, which generates a high density of terrain polygons.

A prior art system 10 is disclosed in FIG. 1. In the system of FIG. 1, the desired real world surface representation is initially provided by database 12, the corrected imagery/raster map of the region of interest. This imagery could, for example, be an overhead view of the geographical area of interest.

The database 12 is processed to produce a vector-based full feature set 14. It is recognized that production of the full feature set 14 is both time consuming and is a source of errors, miscorrelations and loss of fidelity.

As is known, the corrected imagery/raster map 12 could be processed to produce out the window image tiling 16 to at least in part produce visual displays for the simulation participants.

The full feature set 14 can in turn be combined with a terrain grid 18, and a model library 20, to produce terrain triangulation and feature placement information 22. The out the window image tiling 16 and the terrain triangulation and feature placement 22 are stored in visual/infrared database 26. Additional databases such as radar database 28 and semi-automated forces (SAF) or CGF database 30 can also be loaded with the terrain triangulation and feature placement information 22.

The full feature set 14 typically would incorporate a plurality of polygons to represent the respective geometric surfaces. Each polygon would be assigned a single surface type of material. At times, such polygons may cover a large area which could include a plurality of materials. As a result, the limit of a single material per polygon reduces the fidelity of the surface material presentation during the simulation or training exercise. Even when detailed vectors are extracted, the resulting database can be large and complex to process or update, particularly when features are integrated into the terrain skin polygons.

The above-described limitation is particularly evident in systems which include other presentations of a plurality of materials in the area. This discrepancy would be evident if the area is visualized using overhead image resources. It introduces undesirable database correlation issues between systems.

As noted above, the process of extracting the full feature set 14 from the corrected imagery/raster map database 12 requires extensive time and effort. A significant portion of this time and effort is devoted to obtaining the surface material definition for the various polygons. For example, manual digitalization of material outlines from maps or from overhead imagery is often required to provide polygon material definition or assignments. This requires feature extraction time just to support the CGF. The resulting CGF vector features generally provide only a rough outline of the corresponding imagery-based features, creating a source of miscorrelation between systems.

There continues to be an ongoing need to produce synthetic or simulated environments and databases for CGF more rapidly than has heretofore been possible. Additionally, it would be desirable to be able to minimize the errors and loss of fidelity that is often associated with the process of developing vector-based full feature sets, such as set 14.

### BRIEF DESCRIPTION OF THE DRAWINGS

FIG. 1 is a diagram of a prior art system and process of developing databases for a simulation or training environment;

FIG. 2 is a diagram of a system and method in accordance with the invention;

FIG. 2A is a schematic, multi-level image illustrating various aspects of processing in accordance with the invention;

FIGS. 3A, 3B, 3C taken together, illustrate various processes of establishing material coded imagery from various sources;

FIG. 4 illustrates the results of combining material coded imagery with vector features and producing various synthetic environment databases, including a CGF database;

FIG. 5 is an overall flow diagram of a process in accordance with the present invention;

FIG. 6 is a flow diagram of a process for associating material coded image information with various pixels; and

FIG. 7 illustrates an exemplary process of overlaying respective polygons with information associated with respective pixels.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, and as a disclosure of the best mode of practicing the invention. It is not intended to limit the invention to the specific embodiment illustrated.

Systems and methods for creating databases with material coded imagery for computer generated forces in accordance with the invention can shorten preparation time thereby incorporating more flexibility into the training process. Missions can be simulated sooner and with greater realism than with prior art systems.

The use of imagery significantly reduces the amount of vector feature representation that is needed, reducing the time needed to extract features from the imagery. Some vector feature extraction is still required for features that are not represented well by imagery, particularly lineal and point features. However the use of imagery significantly reduces the number of features that must be extracted and improves terrain fidelity.

The present approach for imagery-based SE for CGF takes advantage of the MCI. The MCI is able to represent a large number of features required for the CGF system—especially areal features such as water, grass and forest. MCI can represent feature detail, such as an irregular shoreline or sparse clusters of trees, more quickly and with higher resolution than through vector extraction. Some feature extraction is still required for features that are not represented well by the MCI, particularly smaller lineal and point features, however the overall extraction effort is reduced and correlation of the CGF SE with the other systems is enhanced.

CGF run-time processing incorporates MCI to augment the vector SE. In one aspect of the invention, the CGF can operate either with or without MCI. When MCI is not present, the CGF uses the vector SE data to determine the material characteristics for a sample area in the traditional manner. When MCI is present, the CGF looks at both the MCI and vector data for that area. The CGF determines the material at a given spot by using a priority mechanism to select either the MCI pixel material or the vector material. This method 1) ensures backward compatibility with vector-based CGF data sets, 2) enables usage of datasets with partial MCI coverage, and 3) allows the vector data to add to the feature detail present in the MCI.

In another aspect of the invention, CGF SE is improved by adapting imagery concepts already successfully used for visionics simulation. This provides several advantages:
CGF SE fidelity and correlation with modern visionics simulations is enhanced;
Imagery processing advances can be leveraged to create CGF SE databases more quickly; and
Data processing products already used for other systems can be shared to speed production time even further.

In accordance with the invention, MCI can be used to supplement the traditional physical features as another layer of material attribution. With this approach, MCI pixels can represent many material types that might exist for a particular terrain polygon. This advantageously eliminates the need to subdivide that terrain polygon to capture feature materials.

The MCI representation provides a raster data structure where each pixel in the MCI image maps to a specific geographic area. The size of this MCI pixel area can be varied in order to satisfy the fidelity requirements of the CGF simulation.

Multiple attributes can be represented for each MCI pixel area, such as: soil type, moisture content and feature height. In an exemplary embodiment, MCI pixel height can be defined as the height above terrain, so a pixel height attribute value of 10 meters indicates a canopy 10 meters above the terrain triangle surface at that pixel location.

Both the MCI and vector data can be used. A prioritization scheme can resolve situations where both the MCI and the vector data provide attribution for the same location. The MCI can be viewed as a layer that resides “between” the point/line feature overlay and the terrain polygon foundation.

For a geographic query location, the point/line overlay provides the highest priority definition of the surface material, provided that a point or line exists at that query location. If the point/line overlay is empty at the query location, the MCI layer provides the surface material attribution (if MCI exists.) If the MCI does not exist at that location, then the terrain polygon provides the material attribution. This design also provides for the case where vector features can be defined to “override” or add to the MCI imagery. This can be used for the case where vector data represents features or attribute information not present in the MCI.

In a further aspect of the invention, the use of MCI imagery increases the speed and efficiency of representation of areal features that are traditionally captured in vector form and integrated into the terrain skin. While it is also possible to represent smaller features in the MCI (e.g., buildings, roads), some CGF processing is best done using the vector representation rather than the MCI raster grid representation. As an example, MCI imagery of sufficient resolution can indicate the presence of asphalt material for a road, but the CGF route following algorithm requires a topographical network of the roads. This is not reliably derived by automatic imagery analysis; therefore preferably, the SE representation for road networks (that are to be considered in route planning) will be included in the point/lineal overlay.

In one embodiment of the invention, MCI can enhance the SE representation of some abstract information. For example, the MCI imagery can provide the basis for a CGF map display, eliminating the need to calculate 2D feature outlines for map displays. Some abstract informant such as town names must still be provided in the traditional manner. Other abstract information such as “No-Go” areals could potentially also be represented in the MCI.

The terrain soil type query computes the soil type at a geographic query location. The traditional algorithm searches the terrain polygons within a CTDB region to find the polygon that contains the query point geographic location. The algorithm then accesses the soil attribute of that polygon. In the event that a point or line overlays the terrain polygon at the query location, then the attributes of the point or line take priority and are used instead.

Unlike the prior art, in accordance with the invention, the soil type lookup algorithm first checks whether the MCI image file coverage contains the query point by checking the validity bit in the validity file. If valid data exists, the MCI data can be accessed to determine whether imagery data exists for the pixel that includes the query point. If so, the image data can provide the attribution data. If MCI does not exist, the attribution is obtained from the polygon in the known fashion.

To access the MCI data, the query location is converted to MCI image coordinates, and then the pixel data at that coordinate is read. A publicly available library called “libgeotiff” can be used to implement this process. The coordinate conversion is a time-efficient, linear operation. The image query is also extremely time-efficient, provided the portion of the image being accessed is already paged into physical memory. Paging of imagery data is preferred in a manner similar to vector data.

Points or lines are defined to normally take priority over the MCI. This allows the optional specification of key linear features to override the MCI attribution. Similarly, 3D point objects such as buildings, trees, and countermobility obstacles always have precedence. As a result, images with a coarser resolution can be used without compromising the precision of the 3D feature geometry.

A material coded image may optionally represent elevation data that impacts elevation queries. For example, forest heights may be encoded in the image as a height above terrain for each forest pixel. Like the soil lookup algorithm, the elevation lookup algorithm can evaluate the MCI to determine whether elevation data may exist for a given query point. If so, the elevation contained in the image can be added to the elevation of the terrain skin.

Another CGF algorithm that is impacted by MCI elevation representation is the intervisibility calculation (or “line-of-sight test”.) The traditional algorithm scans the edges of terrain polygons to determine if the line of sight vector intersects the terrain. This algorithm only checks the edges since the highest elevations of a terrain triangle always occur on the edges. In order to account for MCI pixel elevations, the algorithm can be extended to also scan the MCI pixels that lie between terrain edge intersections.

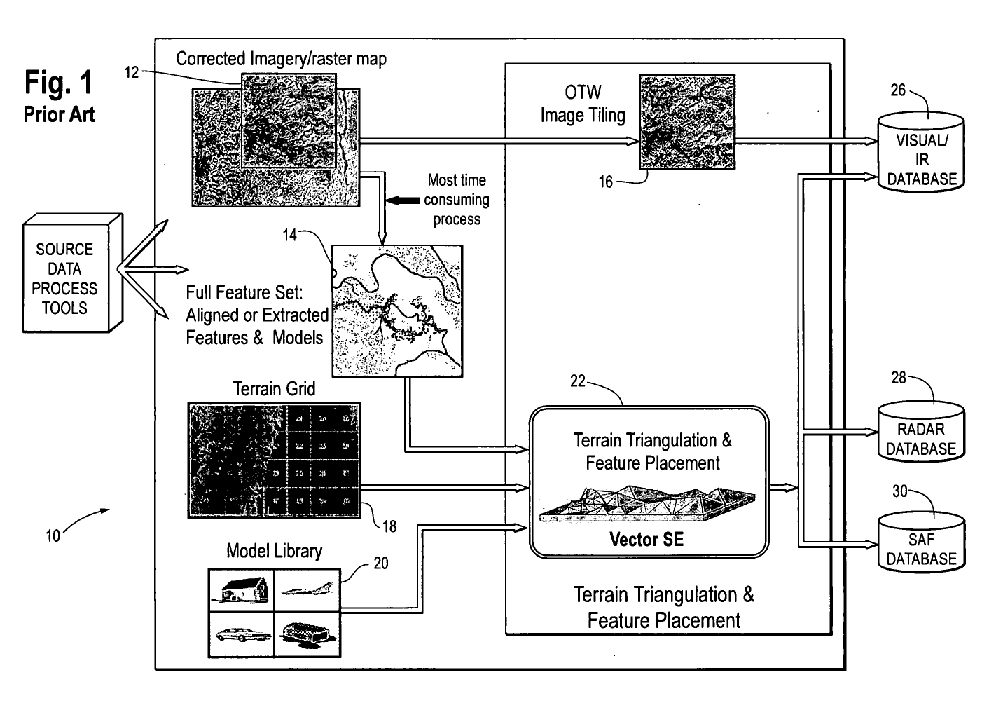

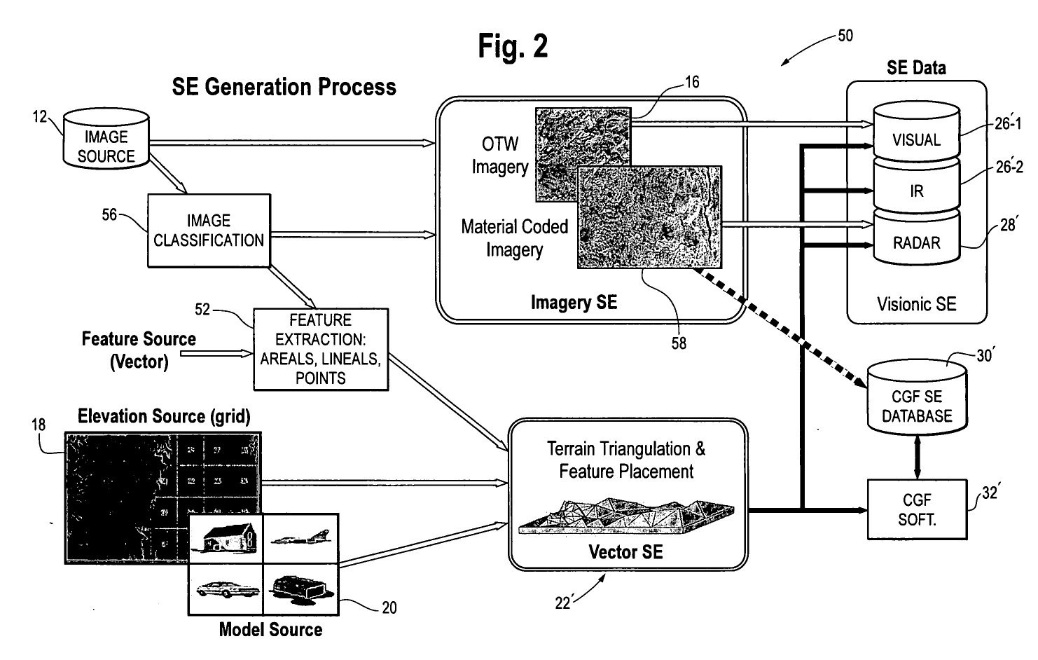

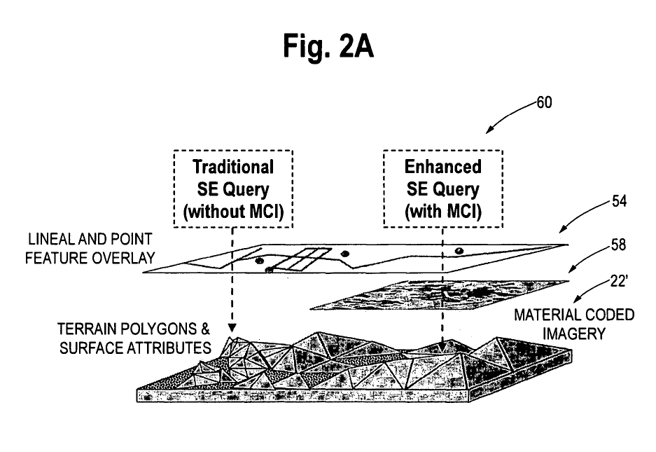

FIG. 2 illustrates a system and process 50 in accordance with the present invention. Those elements of FIG. 2 which correspond to previously discussed elements of FIG. 1 have been assigned the same identification numerals.

Item image classification software 56 of a known type can process data from the corrected image/raster map 12 to form pixel based material coded imagery data 58. For example, each pixel could represent geographical area such as 5 meters square of the region of interest. The pixel based material coded imagery data includes type of surface material present at some or all of the respective pixel.

The corrected image/raster map 12 is processed, using commercially available software, to produce a reduced feature set 52 which can be represented using a plurality of polygons as would be understood by those of skill in the art. The reduced feature set illustrates three dimensional aspects of the terrain of interest along with key lineals; points or other features that are not adequately represented in the material coded imagery. The reduced feature set is generally much smaller than the full feature set, and can even be an empty set, so it can be created more quickly than the full feature set. The reduced feature set 52 is combined with terrain grid 18 and model library 20 to form terrain triangulation and reduced feature placement data 22′.

Each pixel, material coded imagery data 58, is assigned a data value which represents the material for that particular geographical area. For example, and without limitation, indicia and types of material could include:

0 corresponds to a null entry

1 corresponds to water

2 corresponds to sand

3 corresponds to trees

4 corresponds to grass

5 corresponds to concrete

6 corresponds to dirt

Additionally, each pixel material can be assigned a height, as discussed in Donovan U.S. Pat. No. 4,780,084 for a radar simulator and incorporated by reference herein. In such an instance, as described above, the material height for a pixel can be used to modify the underlying elevation for the pixel, increasing fidelity. For example, a pixel with “tree” material may be assign an elevation (e.g. 10 meters), indicating that the pixel is higher than the underlying surface.

The material coded imagery pixels 58 include a geographical position header to identify the location of the respective pixel in the subject environment. For example, each pixel could be identified with either Cartesian or geodesic coordinates. Different resolutions can be provided for different pixels.

More than one type of material can be identified per pixel. In such an instance, pixel data can incorporate multiple codes reflecting multiple types of surfaces or layers present in respective portions of the pixel.

Those of skill will understand that the information from the respective pixels 58 will be layered on terrain surface data 22′. Surface data 22′, for example polygons, can exhibit lineals, areas and default material attributes. Conflicts need to be addressed. Lineals, roads for example, will usually take precedence over MCI data 58. If no MCI data is present for respective coordinates, the default terrain material will be used.

Prioritization can be provided to resolve areas where multiple objects are defined for the same area with different materials. For example, a material coded pixel might be coded for a selected material. On the other hand, three dimensional objects, areals might be present at the corresponding coordinates 22′. In such instances, one form of prioritization can correspond to:

1. Where there is a conflict between material coded imagery 58 and 3D objects, lineals or areals at a respective coordinate or region, lineals, are always assigned a higher priority than the respective material coded imagery 58. Conflicts can be resolved with areals using the following exemplary priority process:

1. MCI priority designation of “true” indicates that the MCI data take priority over the current areal material.

2. MCI priority designation of “false” indicates that the current areal material takes priority over the MCI coded material.

3. MCI priority designation of “available” indicates that MCI data is available for at least part of the respective polygon.

It will be understood that databases 26′-1, 26′-2, 28′ can be used with various simulation programs to present displays for participants (such as visual, IR or radar). Database 30′ can be used by CGF mobilizing software 32′ to provide more realistic force behavior. These databases incorporate respectively, at least material coded imagery 58, and the reduced feature placement data correlated to the triangulated terrain 22′ for purposes of presenting an appropriate display as well as providing enhanced terrain information for CGF.

FIG. 2A illustrates exemplary processing 60 which incorporates material coded imagery, as described above. The process first ascertains the presence or absence of the highest priority information, namely three-dimensional objects, lineals or areals, indicated generally at 54. Such are always assigned a higher priority and utilized for imaging instead of the material coded imagery information, indicated generally at 58. Hence, the material or coded imagery corresponds to a rasterized imagery, or a layer, which for processing purposes can be regarded as being located between the lineal and point feature overlay data 54 and terrain polygon information indicated generally at 22′.

In accordance with the above prioritizing scheme, where material coded imagery 58 is available to provide material or other information, such surface material or other information is utilized in lieu of material attribution associated with the terrain polygon and associated surface attributes 22′ Thus, the present processing is downward compatible with existing databases in the absence of material coded imagery information 58. In such circumstances, the terrain polygon information and associated surface attributes of 22′ are used in the absence of material coded imagery information 58.

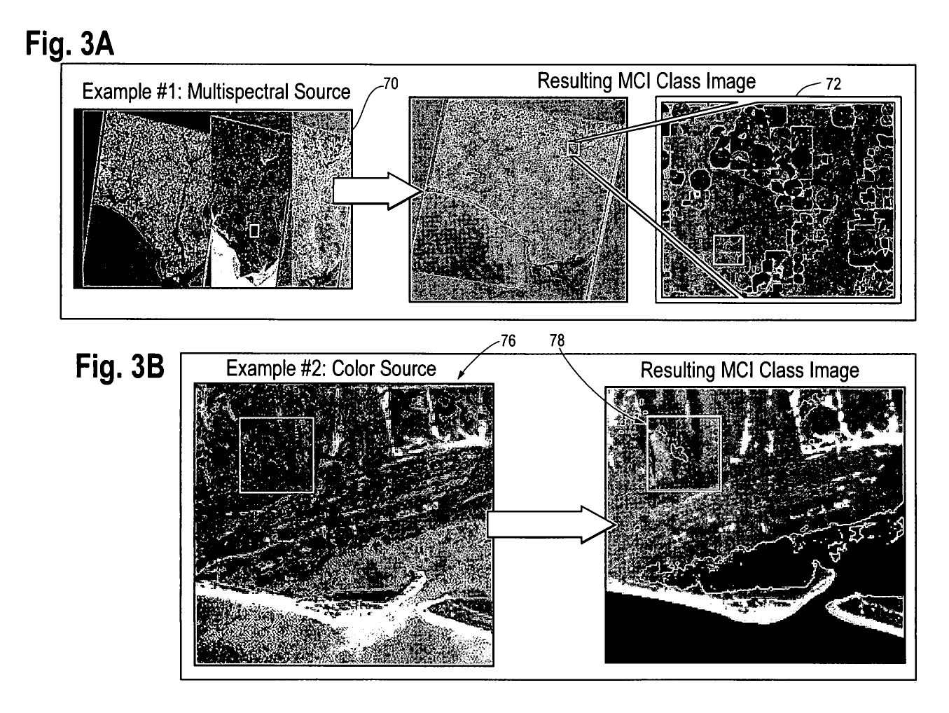

The image classification software can process various types of source data to produce the material coded imagery data 58. FIGS. 3A and 3B illustrate two different sources of data from which the image classification software 56 can produce the material coded imagery data 58. For example, in FIG. 3A, data from a multi-spectral source 70 can be processed by the image classification software 56 to produce material coded imagery data, on a per pixel basis, 72. Similarly, as illustrated in FIG. 3B, color source data 76 can be processed using image classification software 56 to produce pixels, such as pixel 78 of material coded imagery 58.

FIG. 3C illustrates material coded imagery 58 derived from an image 80-1, and correlated with a vector representation, such as representation 80-2. Image 82 illustrates different material classes associated with respective regions of geography 80 in response to processing by image classification software 56.

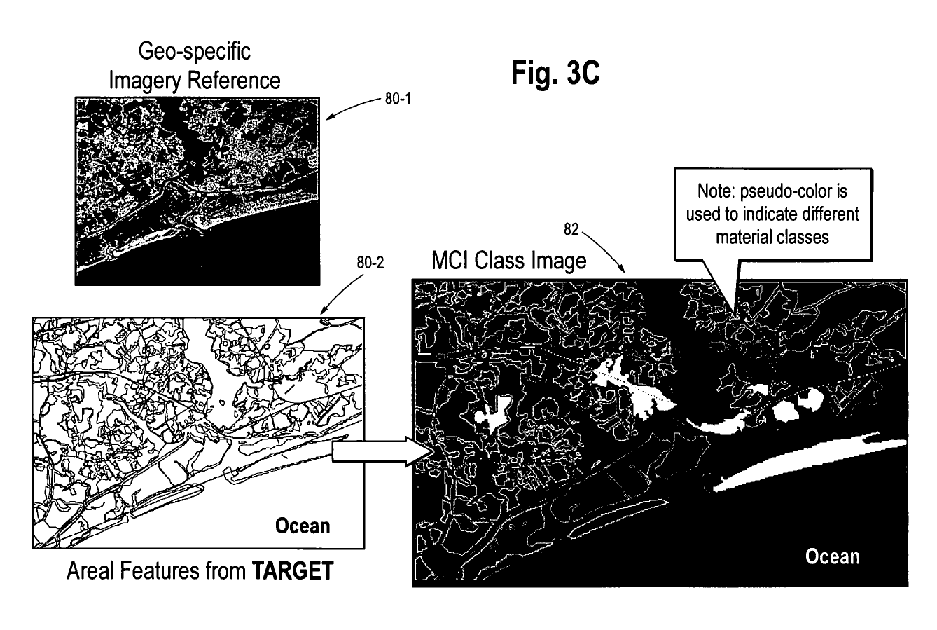

FIG. 4 illustrates exemplary run-time results relative to each of the databases 26′, 28′ and 30′ using the material coded imagery data 58′. In exemplary FIG. 4, the MCI surface information has been obtain from multi-band imagery 70′ to produce pixelized representations with surface indicia 58′.

Correlated run time information associated with respective databases 26′, 28′ and 30′ is illustrated by colorized out the window visual displays and thermal images 26′-1, -2, the respective radar image correlated with vector information from the reduced feature set 52 is illustrated in image 28′-1. Finally, trafficability information usable by the computer generated, or, semi-automated forces, database 30′, is illustrated by display 30′-1.

Database 30′ thus reflects both material coded imagery data 58 as well as the reduced feature set polygonal-type representation 22′. As would be understood by those of skill in the art, the computer generated forces would behave more realistically during a simulation or training exercise than would be the case without the additional material coded data.

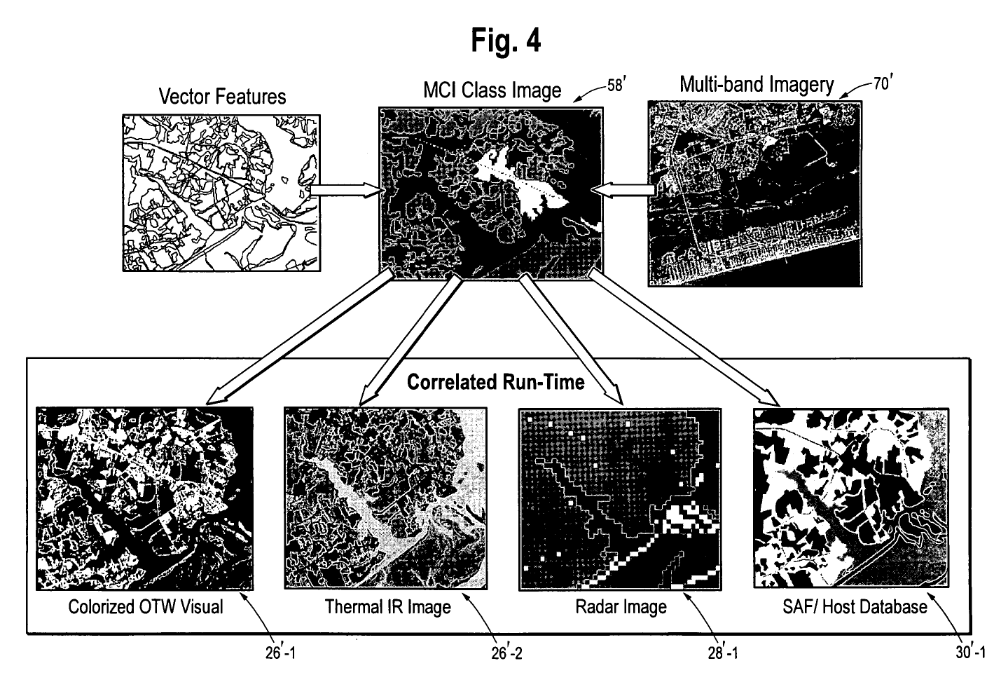

FIG. 5 illustrates additional details of a method 100 in accordance with the invention. In step 102, a particular geographical database, such as the database 12 is selected. In step 104, the material coded imagery information is generated from selected inputs. The reduced feature set of at least part of that database is then created, step 106.

The reduced feature set, such as reduced feature set 52, is combined with terrain grid 18 and model library 20, step 110. The material coded imagery information, such as information 58 can then be stored along with the combined reduced feature set information, terrain grid and library information in respective databases such as 26′, 28′ and 30′, step 112. The stored material coded data and terrain data can be used at simulation run-time, step 114 to improve realism of mobility of computer generated forces.

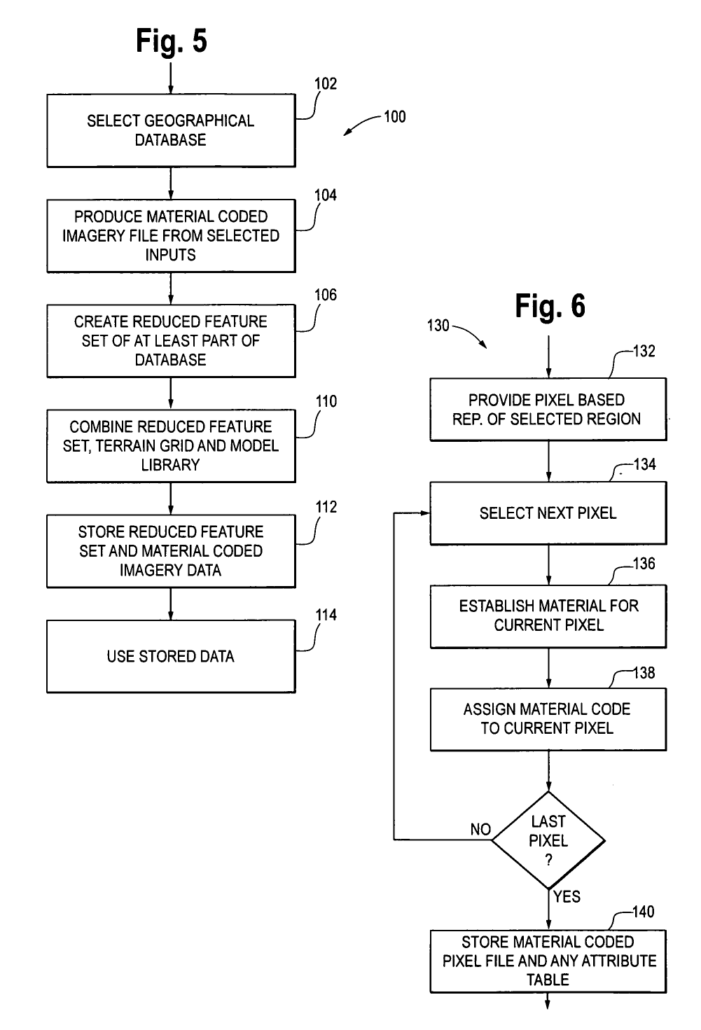

FIG. 6 is an exemplary flow diagram of a process 130 of pixel coding in accordance with the invention. In step 132 a pixel based representation of a selected region is provided. In step 134, the next pixel to be processed is selected.

The material for the current pixel is established, step 136. In step 138 a surface material code is established for the current pixel. If the last pixel has been processed, the material coded pixel data and associated attribute table can be stored in a respective database, step 140. Otherwise, the process returns to step 134 to process the next pixel.

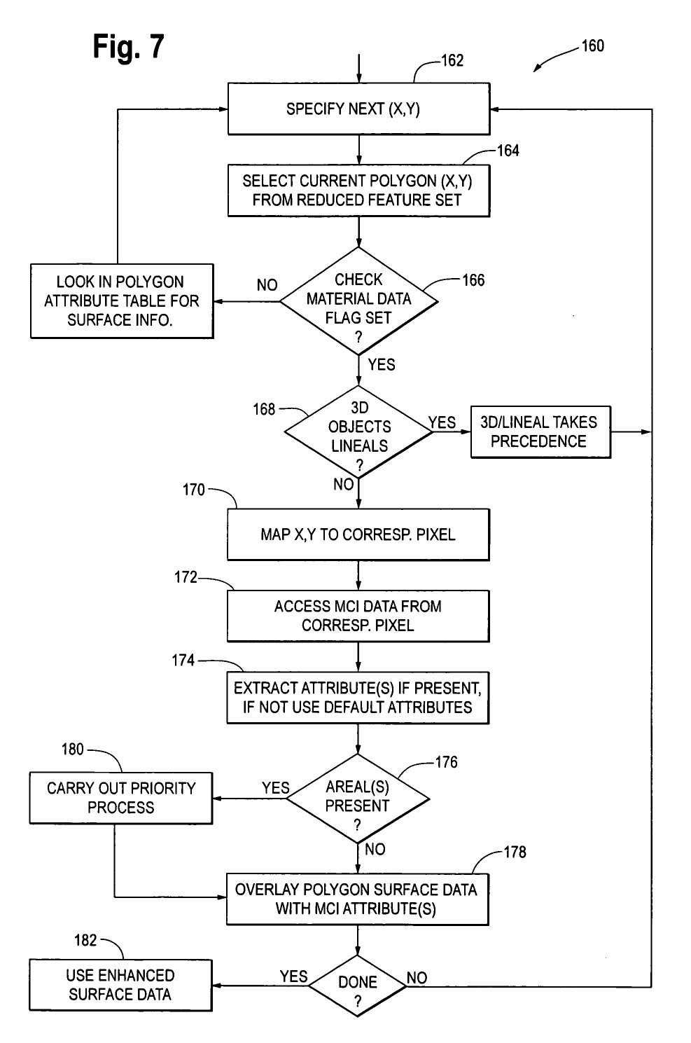

FIG. 7 illustrates yet another exemplary process 160 in accordance with the invention. In the process 160, the material coded data is associated with respective polygons of the reduced feature placement data 22′ which might be stored in a database, such as database 30′.

In a step 162, the next Cartesian coordinate is specified. The respective polygon corresponding to that pair of coordinates is then selected, step 164.

In step 166 a check is made to determine if the material data flag of the respective polygon has been set. If yes, in step 168 an evaluation is carried out to determine if lineals are present. If so, they take priority over any MCI data. If not, the respective coordinates X, Y are mapped to the respective pixel of the material coded imagery 58, step 170. Those of skill in the art will understand that processes are known and available for establishing a correlation between Cartesian coordinates of a region X, Y and the geodedic coordinates of various pixels. One such system has been disclosed in Donovan et al. U.S. Pat. No. 5,751,62 entitled “System and Method for Accurate and Efficient Geodetic Database Retrieval” assigned to the Assignee hereof, and incorporated by reference herein.

In step 172, the respective pixel data is accessed. In step 174 the respective material coded data is extracted for the respective pixel. In step 176 a determination is made if priority needs to be established between a local areal(s) and the respective MCI data. If not, then in step 178, that respective MCI surface information is associated with the respective polygon. Otherwise the prioritizing process, discussed above is carried out, step 180. Then the appropriate material data is associated with the subject polygon, step 178. If finished, the composite polygon information, including the overlayed coded imagery information can be subsequently retrieved and displayed or used in the operation of computer generated forces, step 182. It will be understood that variations in the above processes can be implemented and come within the spirit and scope of the invention.

In summary, processing in accordance with the invention uses material coded imagery to represent feature attribution for CGF run-time processing—without requiring vector extraction or high complexity vector databases. The MCI augments the traditional vector SE, so that features that are not represented well by the MCI can still be captured in the vector SE. The present approach is generally applicable to available CGF/SAF systems.

This approach offers the potential to significantly reduce the database processing time needed for many CGF applications. However the greatest benefit may be for those applications where the CGF must correlate with imagery-based visionics simulations.

Image data can be used to render a SAF tactical map background for a more realistic and information-rich map display. Point and line features can be superimposed on the image.

Rasterized forests with elevation attribution in the image data will not only affect elevation lookups, but also intervisibility queries. Because an image may include several layers, many attributes may be represented for a particular pixel.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A simulation method comprising:
providing an environmental image related database;
establishing a set of coordinates in the database;
relative to the set of coordinates, determining if pre-established lineal or point feature information is available;
in the absence of selected feature information, determining if pre-established surface material related imaging information is available at the established coordinates;
in response to available material related information, combining that surface material information with terrain information associated with the set of coordinates; and
using the combined information in connection with implementing the behavior of computer generated forces.

2. A method as in claim 1 which includes resolving conflicts between selected feature information, surface material information and terrain information for a selected region.

3. A method as in claim 1 which includes establishing a reduced feature set from the database, and, incorporating material related image information into at least regions of the reduced feature set.

4. A method as in claim 3 which includes overlaying a material type on a portion of the reduced feature set as defined by the available material related information.

5. A method as in claim 4 which includes determining coordinates of the surface material related imaging information that correspond to the established coordinates.

6. A method as in claim 1 which includes establishing a material coded imagery file which incorporates the surface material related imaging information.

7. A method as in claim 6 where said surface material related imaging information includes a plurality of material heights corresponding to different surface feature elevations.

8. A method as in claim 3 which includes establishing a terrain file which incorporates reduced feature set information.

9. A method as in claim 8 where the reduced feature set information represents at least some features that are not present in the material coded imagery.

10. A method as in claim 6 where the material coded imagery file incorporates indicia corresponding to a plurality of different surface materials.

11. A method as in claim 6 where the surface materials comprise at least one of sand, earth, water, trees, grass or concrete.

12. A system comprising:
a digital representation of a region;
first software that processes the representation to produce material coded pixels associated with at least portions of the representation;
a database of information defining a region; and
additional software to incorporate information associated with at least some of the material coded pixels into the database for use in defining behavior of computer generated forces.

13. A system as in claim 12 which includes feature software that produces a reduced feature set in part useable to create the database.

14. A system as in claim 13 where the first software is coupled to the feature software.

15. A system as in claim 14 with the feature software also produces a reduced feature terrain representation from a selected digital representation of the region.

16. A system as in claim 15 where the reduced feature terrain representation is combined with information from at least some of the coded pixels and stored in a common database.

17. A system as in claim 16 which includes software which retrieves information from the common database for visual presentation of enhanced terrain imagery.

18. A system comprising:
a database with a geographical feature representation of a selected landscape;
a stored pixel based representation of at least part of the landscape which is coded to represent physical characteristics present at respective pixels; and
software for enhancing the feature representation with physical characteristic information from the pixel based representation.

19. A system as in claim 18 which includes additional software for using the enhanced feature representation in mobilizing computer generated forces.

20. A system as in claim 18 where the software for enhancing includes software for associating coded types of material with respective coordinates of the feature representation.

21. A system as in claim 18 where the software for enhancing includes additional software to determine if a coded material representation is available for use at a selected location of the feature presentation.

22. A system as in claim 21 where the additional software, responsive to the determination, associates at least one material identifying indicium with the selected location.

23. A system as in claim 22 which includes presentation software for presenting the selected location with the identified material thereon.

24. A system as in claim 22 which includes prioritizing software which selectively blocks usage of the identified material in connection with the selected location.

25. A system as in claim 22 where the material identifying indicium specifies at least one of water, dirt, concrete, sand, trees or grass.

26. A system as in claim 22 where the material identifying indicium specifies a material elevation for the corresponding pixel.

27. A system as in claim 22 where the additional software associates a plurality of material identifying indicia with the selected location.

28. A system as in claim 18 where selected pixels of the stored pixel based representation are each coded with a plurality of material indicia.

29. A system as in claim 28 where the software for enhancing includes software for associating a plurality of coded types of material with respective coordinates of the feature representation.

30. A system as in claim 18 which includes additional software for using the feature representation in at least one of presenting an out the window display, or presenting a radar display.

31. A system comprising:
a forces database which includes digital terrain information defining, at least in part, a selected geographical area, and additional information specifying types of physical information relative to various sub-regions of the area;
forces software for implementing a computer generated force scenario with forces movable in at least parts of the area; and
additional software coupled to the database and the forces software for extracting selected terrain information and selected physical information usable by the forces software in moving at least some of the forces in the area.

32. A system as in claim 31 including a visual database having visual digital terrain information related to the area and information specifying types of surface materials present in various sub-regions of the area.

33. A system as in claim 32 including a radar database having radar digital terrain information related to the area and information specifying types of surface materials present in various sub-regions of the area.

34. A system as in claim 31 which includes software for modifying the separate information whereupon the forces software, responsive thereto, modifies movement of at least some of the forces in the area.

35. A system as in claim 31 where the presence of separate information for a selected sub-region is indicated by an indicium associated with selected coordinates in the selected geographical area.
